(19) United States
(12) Patent Application Publication
(10) Pub. No.: US 2023/0082150 A1
(43) Pub. Date: Mar. 16, 2023

(54) INFORMATION PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventors: Xiaoyi ZHANG, Shenzhen (CN); Zhiqiang ZHANG, Shenzhen (CN); Shaoming WANG, Shenzhen (CN); Zheming HONG, Shenzhen (CN); Runzeng GUO, Shenzhen (CN)

(73) Assignee: Tencent Technology (Shenzhen) Company Limited, Shenzhen, Guangdong (CN)

(21) Appl. No.: 17/993,208

(22) Filed: Nov. 23, 2022

Related U.S. Application Data
(63) Continuation of application No. PCT/CN2022/084826, filed on Apr. 1, 2022.

(30) Foreign Application Priority Data
Apr. 23, 2021 (CN) 202110441935.3

(51) Int. Cl. G06Q 20/40; G06V 40/16; G06V 40/10

(52) U.S. Cl. CPC G06Q 20/40145; G06V 40/172; G06V 40/11

(57) ABSTRACT

An information processing method and apparatus, a computer device, and a storage medium are disclosed. In the method, a request to perform a payment operation is received. A service page is displayed and an image of at least one part of a user is captured, in response to the request to perform the payment operation. Authentication of the user is performed based on the captured image of the at least one part of the user. While the authentication of the user is performed, a graphical representation of the at least one part of the user that is generated based on the captured image of the at least one part of the user is displayed. The graphical representation is unique to the user. The payment operation is performed when the user is authenticated based on the captured image of the at least one part of the user.

### RELATED APPLICATIONS

The present application is a continuation of International Application No. PCT/CN2022/084826, entitled “INFORMATION PROCESSING METHOD AND APPARATUS, COMPUTER DEVICE, AND STORAGE MEDIUM” and filed on Apr. 1, 2022, which claims priority to Chinese Patent Application No. 202110441935.3, entitled “INFORMATION PROCESSING METHOD AND APPARATUS, COMPUTER DEVICE, AND STORAGE MEDIUM” and filed with the Chinese Patent Office on Apr. 23, 2021. The entire disclosures of the prior applications are hereby incorporated by reference in their entirety.

### FIELD OF THE TECHNOLOGY

This application relates to the field of computer technologies, including to an information processing technology.

### BACKGROUND OF THE DISCLOSURE

With the continuous development of computer networks, various payment methods have emerged. For example, at present, it is common to realize payment operations by identifying biometrics such as faces and fingerprints.

In the related art, when a user pays for an order with a face ID through a payment device, the payment device collects face information of the user, and then displays the captured face of the user in real time on the device page. In this case, the user can also view the captured face on the payment device. In this scenario, the face of the user directly displayed on the device page is easy to be stolen by a user nearby or other devices, and it is difficult to ensure the security of the face information of the user.

### SUMMARY

This disclosure provides an information processing method and apparatus, a computer device, and a non-transitory computer-readable storage medium, which may improve the security of bioinformation of a target object for example.

According to an aspect of this disclosure, an information processing method is provided. In the method, a request to perform a payment operation is received. A service page is displayed and an image of at least one part of a user is captured, in response to the request to perform the payment operation. Authentication of the user is performed based on the captured image of the at least one part of the user. While the authentication of the user is performed, a graphical representation of the at least one part of the user that is generated based on the captured image of the at least one part of the user is displayed. The graphical representation is unique to the user. The payment operation is performed when the user is authenticated based on the captured image of the at least one part of the user.

According to an aspect of this disclosure, an information processing apparatus is provided. The information processing apparatus includes processing circuitry that is configured to receive a request to perform a payment operation. The processing circuitry is configured to display a service page and capture an image of at least one part of a user, in response to the request to perform the payment operation. The processing circuitry is configured to perform authentication of the user based on the captured image of the at least one part of the user. The processing circuitry is configured to display, while the authentication of the user is performed, a graphical representation of the at least one part of the user that is generated based on the captured image of the at least one part of the user, the graphical representation being unique to the user. The processing circuitry is configured to perform the payment operation when the user is authenticated based on the captured image of the at least one part of the user

According to an aspect of this disclosure, a computer device is provided, including a memory and a processor, the memory storing a computer program, the computer program, when executed by the processor, causing the processor to perform the methods according to various aspects of this disclosure.

According to an aspect of this disclosure, a non-transitory computer-readable storage medium is provided, the non-transitory computer-readable storage medium storing instructions which when executed by a processor, cause the processor to perform the methods according to various aspects of this disclosure.

According to an aspect of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, so that the computer device performs the methods according to various aspects of this disclosure.

In this disclosure, a service page is displayed and bioinformation of a target object is collected according to a biological settlement operation for a target order; cartoon information corresponding to the bioinformation of the target object is displayed in the service page in a process of authenticating the target object based on the bioinformation; and biological settlement information of the target order is displayed. In this way, in the method proposed in this disclosure, cartoon information corresponding to bioinformation of a target object can be displayed in a service page, which improves the security of the bioinformation of the target object. In addition, the bioinformation of the target object is not displayed directly, which can also reduce the visual impact on the target object due to direct display of the bioinformation of the target object, thereby increasing the interest of the target object in using the bioinformation to settle the target order.

### BRIEF DESCRIPTION OF THE DRAWINGS

FIG. 1 is a schematic structural diagram of a network architecture according to an embodiment of this disclosure.

FIG. 2 is a schematic diagram of a scenario of face scan payment according to this disclosure.

FIG. 3 is a schematic flowchart of an information processing method according to this disclosure.

FIG. 4 is a schematic diagram of a service page according to this disclosure.

FIG. 5 is a schematic diagram of a page of selecting background information according to this disclosure.

FIG. 6 is a schematic diagram of a page of settling an order according to this disclosure.

FIG. 7 is a schematic flowchart of an information processing method according to this disclosure.

FIG. 8 is a schematic diagram of a scenario of model training according to this disclosure.

FIG. 9 is a schematic diagram of a scenario of model training according to this disclosure.

FIG. 10 is a schematic flowchart of settling an order according to this disclosure.

FIG. 11 is a schematic structural diagram of an information processing apparatus according to this disclosure.

FIG. 12 is a schematic structural diagram of an information processing apparatus according to this disclosure.

FIG. 13 is a schematic structural diagram of a computer device according to this disclosure.

### DESCRIPTION OF EMBODIMENTS

Technical solutions of this disclosure are described below with reference to the accompanying drawings of this disclosure. The described embodiments are merely some rather than all of the embodiments of this disclosure. Other embodiments fall within the scope of this disclosure.

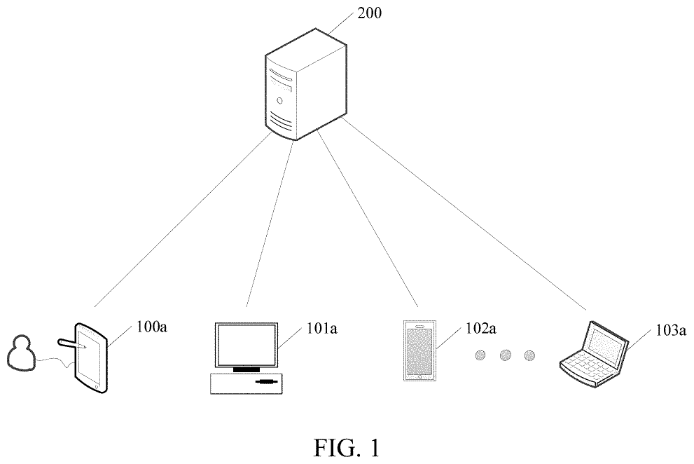

Referring to FIG. 1, FIG. 1 is a schematic structural diagram of a network architecture provided by an embodiment of this disclosure. As shown in FIG. 1, the network architecture may include a server 200 and a terminal device cluster, and the terminal device cluster may include one or more terminal devices. The quantity of the terminal devices is not limited here. As shown in FIG. 1, the plurality of terminal devices may specifically include a terminal device 100a, a terminal device 101a, a terminal device 102a . . . and a terminal device 103a. As shown in FIG. 1, the terminal device 100a, the terminal device 101a, the terminal device 102a . . . and the terminal device 103a may all be in network connection with the server 200, so that each terminal device is in data interaction with the server 200 by using the network connection.

The server 200 shown in FIG. 1 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data an artificial intelligence platform.

The terminal device 100a, the terminal device 101a, the terminal device 102a . . . and the terminal device 103a may all be terminal devices for users, such as a smart phone, a tablet computer, a laptop computer, a desktop computer, a smart TV, a frog device (devices deployed offline to support users to complete order payment through face scanning and other operations) or other smart devices. The user may request the server 200 to complete the face scan payment for an order together through the foregoing terminal device, and in the process of face scan payment, the terminal device displays a cartoon image of the user on a display interface to replace the actually collected face image with the cartoon image. The order may be a commodity order generated by a target user through a shopping application (which may be the shopping platform below), and the face scan payment may be completed in a payment application (equivalent to the settlement software below). The shopping application and the payment application may be the same application, or may be different applications. In a case that the shopping application and the payment application are different applications, the payment application may be called, through the shopping application, to pay for the order, and the server 200 may be a back-end server of the payment application. The communication between the terminal device 100a and the server 200 is used as an example for detailed description of this embodiment of this disclosure.

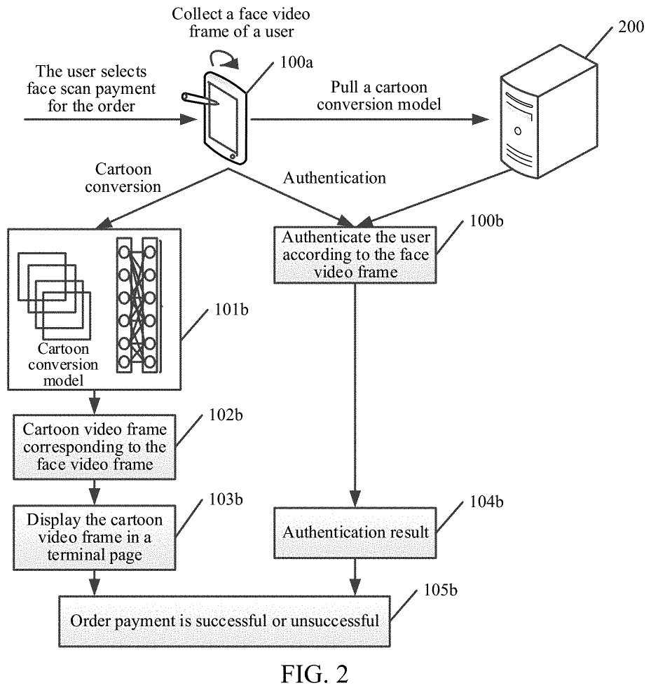

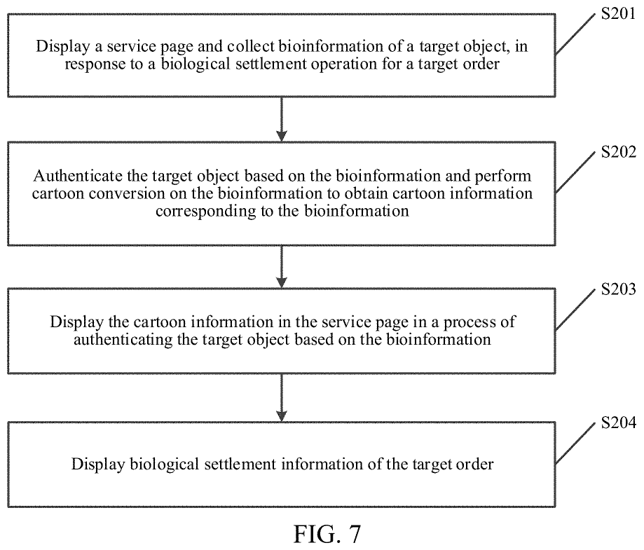

Referring to FIG. 2 together, FIG. 2 is a schematic diagram of a scenario of face scan payment according to this disclosure. As shown in FIG. 2, the terminal device 100a may turn on the camera and collect a face video frame of the user (a captured image including the face of the user), in response to a face scan operation for an order triggered by the user through the payment application. In addition, the terminal device 100a may pull a cartoon conversion model 101b from the server 200. The cartoon conversion model 101b may convert the captured image including an actual face of the user into a cartoon image. For a specific training process of the cartoon conversion model 101b, reference may be made to the following description in the embodiment corresponding to FIG. 7.

In this way, the terminal device 100a may input the collected face video frame of the user into the cartoon conversion model 101b, and a cartoon video frame 102b (cartoon image) corresponding to the face video frame of the user may be generated through the cartoon conversion model 101b. At the same time, the terminal device 100a may further authenticate the user based on the collected face video frame (as shown in block 100b), and in a process of authenticating the user, the terminal device 100a may display a cartoon video frame of the user in a terminal page (as shown in block 103b). In the process of authenticating the user, the terminal device 100a may authenticate the user jointly with the server 200, thereby obtaining an authentication result 104b for the user. For the specific process of authenticating the user, reference may be made to the following description in the embodiment corresponding to FIG. 7. The authentication result 104b may indicate that the authentication for the user fails, or the authentication for the user succeeds.

Through the foregoing authentication result 104b, the terminal device may obtain a payment result 105b for the order of the user. The payment result 105b may indicate that the payment for the order of the user fails, or the payment for the order of the user succeeds. Specifically, in response to the authentication result 104b indicating that the authentication for the user succeeds, the server 200 may pay for the order of the user through a payment account (such as an account registered by the user through the forgoing payment application) associated with the user. Upon obtaining prompt information that payment for the order of the user succeeds, the server 200 may transmit the prompt information that the payment for the order of the user succeeds to the terminal device 100a, and the terminal device 100a may obtain the foregoing payment result 105b based on the prompt information that the payment for the order of the user succeeds. In this case, the payment result represents that the payment for the order of the user succeeds. Upon obtaining prompt information that the payment for the order of the user fails, the server 200 may transmit the prompt information that the payment for the order of the user fails to the terminal device 100a, and the terminal device 100a may obtain the foregoing payment result 105b based on the prompt information that the payment for the order of the user fails. In this case, the payment result represents that the payment for the order of the user fails. On the contrary, in a case that the authentication result 104b represents that the authentication for the user fails, the server 200 may not pay for the order of the user. In this case, the prompt information that the payment for the order of the user fails is obtained, the server 200 may transmit the prompt information that the payment for the order of the user fails to the terminal device 100a, and the terminal device 100a may obtain the foregoing payment result 105b based on the prompt information that the payment for the order of the user fails. In this case, the payment result represents that the payment for the order of the user fails.

Through the method provided in this disclosure, in a process of the face scan payment of the user, the actual face of the user may not be displayed, and a cartoon face similar to the actual face of the user is displayed, thereby reducing the visual impact on the user due to the displayed actual face, and increasing the interest of the user in the face scan payment. In addition, by displaying the cartoon face, the security of the actual face of the user may further be improved.

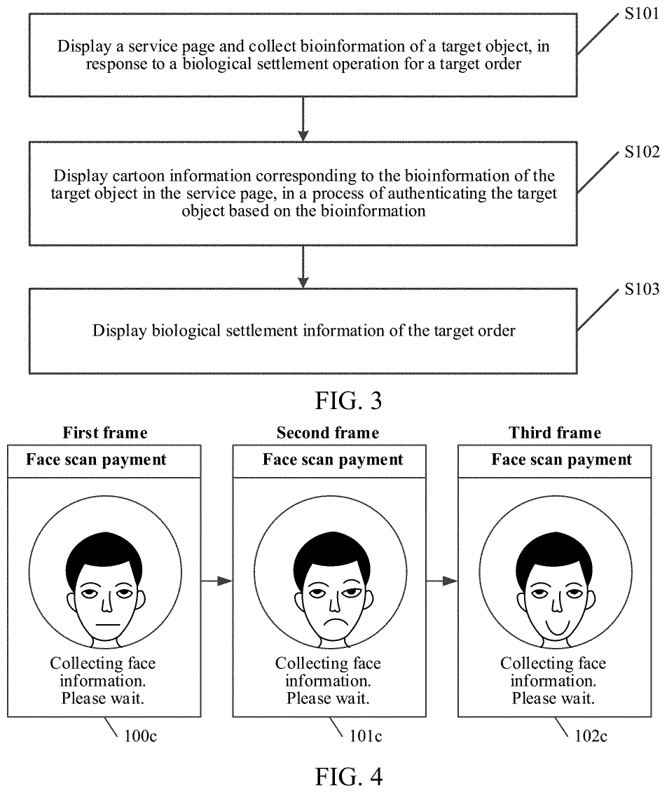

Referring to FIG. 3, FIG. 3 is a schematic flowchart of an information processing method according to this disclosure. In an embodiment of this disclosure, an executing body may be a computer device, or a computer device cluster including multiple computer devices. The computer device may be a server, or a terminal device. Therefore, in the embodiment of this disclosure, the executing body may be a server, or a terminal device, or a combination of the server and the terminal device. In this case, the executing body in this disclosure being a terminal device is taken as an example for description. As shown in FIG. 3, the method may include the following steps:

In step S101, a service page is displayed and bioinformation of a target object collected, in response to a biological settlement operation for a target order.

In this disclosure, settlement may refer to payment, and the target order may be any order that needs to be paid for and settled. For example, the target order may be a payment order for a selected commodity on a shopping platform. For another example, the target order may be an online payment order for a selected commodity in an offline store. The biological settlement operation is an operation to pay for and settle the target order. Specifically, the biological settlement operation is an operation of authenticating a target object based on bioinformation of the target object that triggers payment for the target order, and then performing settlement and payment for the target order according to an authentication result. The target order may be an order of the target object, the target object may be any user, and the bioinformation of the target object refers to any bioinformation for authenticating the target object, such as face information, pupil information, palmprint information, or fingerprint information of the target object.

Therefore, the terminal device may display the service page and collect the bioinformation of the target object, according to the biological settlement operation of the target object for the target order. The service page may be construed as a shooting page, and in this service page, cartoon information corresponding to the bioinformation of the target object may be displayed, referring to the following step S102.

The terminal device may display a settlement method list in the terminal page, and the settlement method list may include one or more settlement methods for the target object. For example, the settlement method list may include a face settlement method, a pupil settlement method, a fingerprint settlement method and a palmprint settlement method. The terminal device may display the service page and collect the bioinformation corresponding to the settlement method selected by the target object, according to a selection operation of the target object for the settlement methods in the settlement method list. The selection operation of the target object for the settlement methods in the settlement method list may be the foregoing biological settlement operation. In a case that the settlement method selected by the target object is the face settlement method, the bioinformation of the target object collected may be the face information of the target object; in a case that the settlement method selected by the target object is the pupil settlement method, the bioinformation of the target object collected may be the pupil information of the target object; in a case that the settlement method selected by the target object is the fingerprint settlement method, the bioinformation of the target object collected may be the fingerprint information of the target object; in a case that the settlement method selected by the target object is the palmprint settlement method, the bioinformation of the target object collected may be the palmprint information of the target object; and so on.

In step S102, cartoon information corresponding to the bioinformation of the target object is displayed in the service page, in a process of authenticating the target object based on the bioinformation.

In this disclosure, the terminal device may authenticate the target object based on the collected bioinformation of the target object, or, the terminal device may transmit the collected bioinformation of the target object to a back-end server, to cause the server to authenticate the target object based on the bioinformation. The terminal device may display the cartoon information corresponding to the bioinformation of the target object in the service page in the process of authenticating the target object based on the collected bioinformation, referring to the following description.

In a possible implementation, the bioinformation of the target object collected by the terminal device may include an i-th face video frame and a j-th face video frame obtained by photographing the target object, and the i-th face video frame and the j-th face video frame include a face image of the target object. Therefore, the i-th face video frame and the j-th face video frame include the face information of the target object. The i-th face video frame and the j-th face video frame may be any two adjacent face video frames obtained by the terminal device when photographing the target object for collecting the bioinformation. A face video frame is essentially an image. Both i and j are positive integers less than or equal to the total number of all face video frames captured in the process of collecting the bioinformation of the target object. The i-th face video frame is the previous frame of the j-th face video frame. Each of the i-th face video frame and the j-th face video frame has a face display attribute of the target object, and the face display attribute may include at least one of the following: a face pose attribute, a face expression attribute, and a face accessory attribute. The face pose attribute may represent a tilt degree of the face of the target object (for example, whether the head is tilted, lowered or raised), the face expression attribute may represent a facial expression of the target object (such as a happy expression, a sad expression, or a surprised expression), and the face accessory attribute may represent accessories worn on the face of the target object (such as glasses or contact lenses). The above face display attributes are only examples.

In addition, the cartoon information corresponding to the bioinformation of the target object may include a cartoon face video frame corresponding to the i-th face video frame and a cartoon face video frame corresponding to the j-th face video frame. Therefore, at a first moment corresponding to the i-th face video frame (the first moment may be construed as a moment at which the i-th face video frame is collected), the terminal device may display the cartoon face video frame corresponding to the i-th face video frame in the service page based on the face display attribute of the i-th face video frame. The cartoon face video frame includes the cartoon face corresponding to the face of the target object in the i-th face video frame. The cartoon face has the face display attribute of the i-th face video frame, but the i-th face video frame has an actual face display attribute of the target object, and the cartoon face has a cartoon face video frame of the target object.

In this way, when time elapses from the first moment to a second moment corresponding to the j-th face video frame (the second moment may be construed as a moment at which the j-th face video frame is collected), the terminal device may display the cartoon face video frame corresponding to the j-th face video frame in the service page according to the face display attribute of the j-th face video frame. The cartoon face video frame includes the cartoon face corresponding to the face of the target object in the j-th face video frame. The cartoon face has the face display attribute of the j-th face video frame, but the j-th face video frame has the actual face display attribute of the target object, and the cartoon face has the cartoon face video frame of the target object.

It may be construed as that, in a case that the bioinformation (such as each face video frame) of the target object is collected, the cartoon information (such as the cartoon face video frame corresponding to each face video frame) corresponding to the bioinformation may be displayed synchronously in the service page, that is, the delay between collecting the bioinformation and displaying the cartoon information (such as collecting a face video frame and displaying a cartoon face video frame corresponding to the face video frame) is very short, which may be considered as synchronous.

The bioinformation of the target object may include a collected face image of the target object, and the face image may be any collected face video frame of the target object when displayed in the service page. Therefore, the cartoon information corresponding to the bioinformation of the target object may include the cartoon face image corresponding to the face image, the cartoon face image may be construed as the cartoon face video frame corresponding to the face image, and the cartoon face image includes the cartoon face corresponding to the actual face of the target object in the face image.

Therefore, similarly, the terminal device may display the cartoon face image in the service page according to the face display attribute of the face image of the target object.

The bioinformation of the target object may include a collected palmprint image of the target object, and the palmprint image may be any collected palmprint video frame of the target object when displayed in the service page. The palmprint image may be an image obtained by photographing a palm of the target object, and the palmprint image includes palmprint information of the target object. Therefore, the cartoon information corresponding to the bioinformation of the target object may include a cartoon palmprint image corresponding to the palmprint image, the cartoon palmprint image may be construed as a cartoon palmprint video frame corresponding to the palmprint image, and the cartoon palmprint image includes a cartoon palm corresponding to an actual palm of the target object in the palmprint image.

Therefore, similarly, the terminal device may display the cartoon palmprint image in the service page according to a palmprint display attribute of the palmprint image of the target object. For example, the palmprint display attribute may include at least one of a palmprint pose attribute and a palmprint accessory attribute. The palmprint pose attribute may include a tilt degree and an opening degree of the palm of the target object in the palmprint image, and the palmprint accessory attribute may include accessories (such as a ring) worn on the palm of the target object in the palmprint image. The cartoon palmprint image has the palmprint display attribute of the palmprint image, but the palmprint image has an actual palmprint display attribute of the target object, and the cartoon palmprint image has a cartoon palmprint display attribute of the target object.

The bioinformation of the target object may include a collected pupil image of the target object, and the pupil image may be any collected pupil video frame of the target object when displayed in the service page. The pupil image may be an image obtained by photographing eyes of the target object, and the pupil image includes pupil information of the target object. Therefore, the cartoon information corresponding to the bioinformation of the target object may include a cartoon pupil image corresponding to the pupil image, the cartoon pupil image may be construed as a cartoon pupil video frame corresponding to the pupil image, and the cartoon pupil image includes cartoon eyes corresponding to the actual eyes of the target object in the pupil image.

Therefore, similarly, the terminal device may display the cartoon pupil image in the service page according to a pupil display attribute of the pupil image of the target object. For example, the pupil display attribute may include at least one of a pupil closure attribute and a pupil accessory attribute. The pupil closure attribute may include an opening or closing degree of the pupil of the target object in the pupil image, and the pupil accessory attribute may include accessories (such as contact lenses) worn on the pupil of the target object in the pupil image. The cartoon pupil image has the pupil display attribute of the pupil image, but the pupil image has an actual pupil display attribute of the target object, and the cartoon pupil image has a cartoon pupil display attribute of the target object.

Accordingly, the bioinformation of the target object collected by the terminal device may be a plurality of video frames (such as the foregoing face video frame, pupil video frame, or palmprint video frame) obtained by photographing a certain biological part (such as a face, a pupil or a palmprint) of the target object. The plurality of video frames include information about the biological part (such as the face information, the pupil information, or the palmprint information) of the photographed target object. The cartoon information corresponding to the bioinformation of the target object includes the cartoon video frame (such as the foregoing cartoon face video frame, cartoon pupil video frame, or cartoon palmprint video frame) corresponding to each video frame. When collecting each video frame, the terminal device may display the cartoon video frame corresponding to each video frame in turn in the service page synchronously, such that in the process of photographing the target object, the cartoon image corresponding to the actually photographed target object (such as the cartoon face image, the cartoon palmprint image, or the cartoon pupil image) instead of the actually photographed target object (such as the face of the actual shot target object) is displayed. In addition, in the shooting process, in response to any action or change of the target object, the cartoon image displayed in the service page may also generate the same action or change. It is to be understood that, the target object in the video frame is similar to the cartoon image in the cartoon video frame corresponding to the video frame, but the video frame includes the actually photographed target object, and the cartoon video frame includes the cartoon image or another graphical representation corresponding to the photographed target object.

Referring to FIG. 4, FIG. 4 is a schematic diagram of a service page according to this disclosure. The cartoon information of the target object displayed in the service page may be dynamic. As shown in FIG. 4, a service page 100c, a service page 101c, and a service page 102c display a cartoon face video frame corresponding to the first face video frame of the target object, a cartoon face video frame corresponding to the second face video frame of the target object, and a cartoon face video frame corresponding to the third face video frame of the target object in order. The interval between adjacent cartoon face video frames can be short. Therefore, displaying each cartoon face video frame sequentially and continuously achieves a dynamic display effect. In this case, it may be considered that a cartoon face video composed of a plurality of cartoon face video frames is displayed.

For example, in a case that the bioinformation is a video frame obtained by photographing a certain biological part of the target object, and the cartoon information corresponding to the bioinformation is a cartoon video frame corresponding to the video frame, the cartoon video frame may not include a background of the photographed target object in the video frame, but only includes the cartoon image corresponding to the photographed target object. Therefore, the terminal device may further display a background selection list in the service page. The background selection list may include M types of background information, and M is a positive integer. The specific value of M may be determined according to the actual application scenario, which is not limited. The terminal device may determine background information selected by the target object as target background information of the cartoon image of the target object in the cartoon video frame according to a selection operation for the M types of background information of the target object, and display the cartoon information and the target background information in the service page synchronously, which may be understood as synthesizing the target background information with the cartoon video frame, where the synthesized cartoon video frame includes the cartoon image of the photographed target object and the target background information.

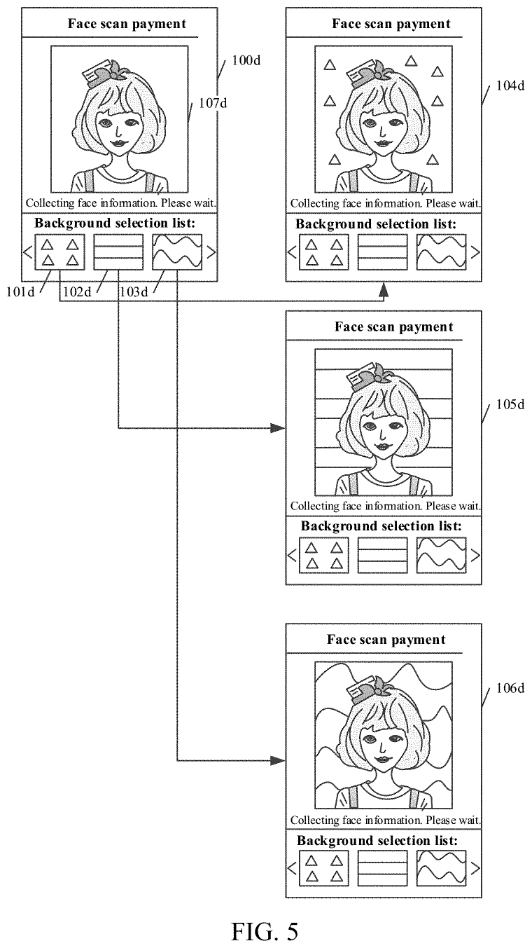

Referring to FIG. 5, FIG. 5 is a schematic diagram of a page of selecting background information according to this disclosure. As shown in FIG. 5, a cartoon video frame 107d corresponding to the video frame obtained by photographing the target object is displayed in a service page 100d. The service page 100d further includes a background selection list. The background selection list includes the M types of optional background information for the target object, such as background information 101d, background information 102d, and background information 103d. As shown in FIG. 5, in a case that the target object does not select the background information in the service page 100d, a background of the cartoon image of the target object in the displayed cartoon face video frame is blank.

In a case that the target object selects the background information 101d in the service page 100d, the terminal device may be switched from displaying the service page 100d to displaying a service page 104d. As shown in the service page 104d, the background information of the cartoon image of the target object in the displayed cartoon face video frame is the background information 101d, that is, the background information of the cartoon image of the target object in the displayed cartoon face video frame includes many small triangles.

Similarly, in a case that the target object selects the background information 102d in the service page 100d, the terminal device may be switched from displaying the service page 100d to displaying a service page 105d. As shown in the service page 105d, the background information of the cartoon image of the target object in the displayed cartoon face video frame is the background information 102d, that is, the background information of the cartoon image of the target object in the displayed cartoon face video frame includes many straight lines.

Similarly, in a case that the target object selects the background information 103d in the service page 100d, the terminal device may be switched from displaying the service page 100d to displaying a service page 106d. As shown in the service page 106d, the background information of the cartoon image of the target object in the displayed cartoon face video frame is the background information 103d, that is, the background information of the cartoon image of the target object in the displayed cartoon face video frame includes many wavy lines.

The foregoing background information 101d, background information 102d, and background information 103d are only examples, and the specific content of the background information may be set in various manners.

In step S103, biological settlement information of the target order is displayed.

In this disclosure, the biological settlement information may be displayed in the service page, or the biological settlement information may further be displayed in a new page rather than the service page. In a case that the authentication for the target object by the terminal device based on the bioinformation ends, the corresponding biological settlement information is displayed, and the displayed biological settlement information is determined at least according to an authentication result of the target object.

The biological settlement information may include several cases as follows:

In an example, in a case that the authentication for the target object based on the bioinformation succeeds, the target order may be settled through a settlement account associated with the target object, and settlement success information is generated. The settlement success information may be regarded as the biological settlement information, and in this case, the biological settlement information is used for prompting that the target object successfully settles the target order.

In an example, in a case that the authentication for the target object based on the bioinformation fails, indicating that a settlement account associated with the target object cannot be obtained, in this case, the settlement of the target order fails, and the terminal device may generate settlement failure information. The settlement failure information may be regarded as the biological settlement information, and in this case, the biological settlement information is used for prompting that the target object fails to settle the target order.

The foregoing target order may be settled through settlement software, and the foregoing biological settlement operation may further be performed in the settlement software. The target object may be a user of the settlement software, that is, the target object registers a user account in the settlement software. Therefore, the settlement account associated with the target object may be an account bound to the user account (such as a balance account or a bank account in the settlement software) in the settlement software of the target object. Therefore, it is to be understood that, the authentication for the target object through the bioinformation being successful may refer to that the user account of the target object in the settlement software is obtained through verification based on the bioinformation. On the contrary, the authentication for the target object through the bioinformation being failed may refer to that the user account of the target object in the settlement software cannot be obtained through verification based on the bioinformation.

In an example, in a case that the authentication for the target object based on the bioinformation succeeds, the terminal device may further generate settlement confirming information. The settlement confirming information may be regarded as the biological settlement information, and in this case, the biological settlement information is used for supporting the user to settle the target order, that is, allow the user to settle the target order after confirmation. For example, the settlement confirming information may include a mask code (such as a mask code of a phone number associated with the user account) of the user account of the target object obtained in the settlement software through verification, or include an avatar of the user account of the target object. The terminal device may settle the target order by using the settlement account associated with the target object according to a confirming operation of the target object for the settlement confirming information.

There may be more than one (at least two) settlement account associated with the target object. Therefore, after the terminal device detects the confirming operation of the target object for the settlement confirming information, an account selection list may further be displayed. The account selection list may include N settlement accounts associated with the target object. N is a positive integer, and the specific value of N is determined according to the actual application scenario. Therefore, the terminal device may further determine a settlement account selected by the target object as a target settlement account according to a selection operation for the N settlement accounts in the account selection list of the target object, and settle the target order through the target settlement account.

The operation of settling the target order by the terminal device may be that the terminal device requests the back end of the settlement software to settle the target order, and then settles the target order through the back end of the settlement software. After the settlement is successful, the back end of the settlement software may return a settlement result to the terminal device.

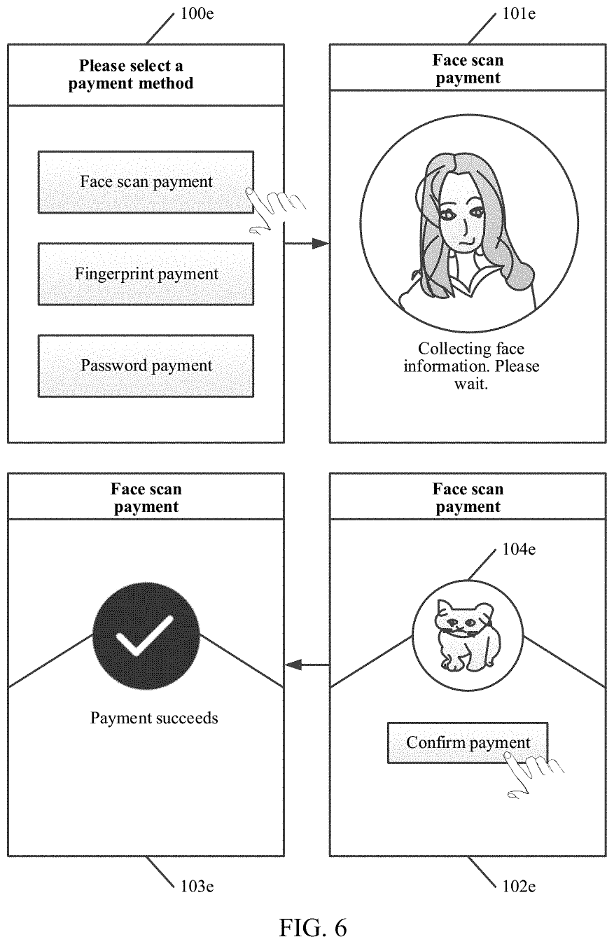

Referring to FIG. 6, FIG. 6 is a schematic diagram of a page of settling an order according to this disclosure. As shown in FIG. 6, a payment method list is displayed in a terminal page 100e. The list includes three types of payment methods, specifically including the face scan payment method, the fingerprint payment method, and the password payment method. The terminal device may display a service page 101e according to a selection operation (the selection operation may be the foregoing biological settlement operation) of the user for the face scan payment method in the terminal page 100e. A cartoon image corresponding to the actual image of the target object photographed by a camera may be displayed in the service page 101e.

In addition, the terminal device may further authenticate the target object based on the actual image of the target object photographed by the camera, or, the terminal device may transmit the actual image of the target object photographed by the camera to a back-end server, to cause the server to authenticate the target object based on the actual image. In a case that the authentication for the target object succeeds, the server may be switched from displaying the service page 101e to displaying a terminal page 102e, and the terminal page 102e may include an avatar 104e of the user account of the target object. The terminal device may request the back end of the settlement software to use the settlement account (which may be a default settlement account) associated with the target object to settle the target order, according to the confirming operation (such as a clicking operation) for a “Confirm Payment” button in the terminal page 102e of the target object. After the settlement succeeds, the prompt information of successful settlement is returned to the terminal device. The terminal device may be switched from displaying the terminal page 102e to displaying a terminal page 103e according to the prompt information. The terminal page 103e may prompt the target object that the target order is settled successfully (that is, the payment succeeds).

In the method provided in this disclosure, in a case that the target order is settled based on the bioinformation, the service page may not display the actually photographed target object, but display the cartoon information of the photographed target object, which may reduce the psychological impact on a user due to the presentation of the actual bioinformation, reduce the psychological discomfort for the user, increase interest of the user in using the bioinformation to settle the target order, and improve the utilization of the related technology for order settlement through the bioinformation. In addition, the cartoon information corresponding to the bioinformation of the target object is displayed in the service page, which may further improve the security of the bioinformation of the target object.

Referring to FIG. 7, FIG. 7 is a schematic flowchart of an information processing method according to this disclosure. The method described in this embodiment of this disclosure is the same as that described in the embodiment corresponding to FIG. 3, except that the embodiment corresponding to FIG. 3 focuses on the description of some contents perceived by the user, while this embodiment of this disclosure focuses on the description of the specific implementation principle of the method. Therefore, the executing body in this embodiment of this disclosure may be the executing body in the embodiment corresponding to FIG. 3, and the contents described in this embodiment of this disclosure may also be combined with the contents described in the embodiment corresponding to FIG. 3. As shown in FIG. 7, the method may include the following steps:

In step S201, a service page is displayed and bioinformation of a target object is collected, in response to a biological settlement operation for a target order.

In this disclosure, the collected bioinformation of the target object being face information of the target object is taken as an example for description. It is to be understood that, in addition to the face information, other bioinformation (such as pupil information or palmprint information) may further be collected. Therefore, after the terminal device detects the biological settlement operation triggered for the target order by the target object, a camera may be called to photograph the face of the target object in front of the camera, to obtain L face video frames of the target object. L is a total number of face video frames obtained by photographing the target object. L is a positive integer. The specific value of L is determined according to the actual application scenario. The L face video frames may be regarded as the bioinformation of the target object.

In step S202, the target object is authenticated based on the bioinformation and cartoon conversion is performed on the bioinformation to obtain cartoon information corresponding to the bioinformation.

In this disclosure, it is to be understood that, the process of authenticating the target object based on the bioinformation and the process of performing cartoon conversion on the bioinformation to obtain the cartoon information may be independent and parallel execution processes.

The process of authenticating the target object based on the bioinformation may be as follows:

The terminal device may select a face video frame from the L face video frames, determine the selected face video frame as a target video frame, and authenticate the target object according to the target video frame. An optimal frame may be selected from the L face video frames as the target video frame. The optimal frame may be a video frame with the highest definition in the L face video frames, or may be a video frame with the most complete face information in the L face video frames. The method of authenticating the target object based on the target video frame by the terminal device may be as follows:

In a case that the terminal device collects the target video frame, a depth video frame corresponding to the target video frame may further be collected. The target video frame is a plane image. The target video frame includes plane information of the face of the target object, and the depth video frame may be construed as a three-dimensional image, including depth information of the face of the target object (which may be called face depth information), which may be construed as three-dimensional information of the face of the target object.

Therefore, the terminal device may obtain facial feature plane information of the target object from the target video frame. Facial features may refer to the two eyes, nose, and two corners of the mouth of the target object. In this case, the facial feature plane information may include information such as the two eyes, the nose, and a distance between the two corners of the mouth of the target object. The terminal device may obtain the facial feature depth information of the target object from the depth video frame corresponding to the target video frame. The facial feature depth information may include protruding or concave contours of the two eyes, nose, two corners of the mouth, and other information of the target object. The facial feature plane information and the facial feature depth information of the target object obtained by the terminal device may be used as five-point information of the target object, and the five-point information may be transmitted to the back end of the settlement software. The back end of the settlement software may compare the five-point information of the target object with five-point information of all users stored in the database to determine the identity of the target object. For example, a user whose five-point information stored in the database is highly similar to the five-point information of the target object may be considered as the target object. In this case, it is considered that the authentication for the target object is successful, and the back end of the settlement software may return the prompt information of successful authentication for the target object to the terminal device (such as the settlement software in the terminal device). In a case that there is no five-point information highly similar to the five-point information of the target object in the database, it is considered that the authentication for the target object fails, and the back end of the settlement software may return the prompt information of failed authentication for the target object to the terminal device (such as the settlement software in the terminal device). The five-point information being highly similar may be specifically interpreted as a similarity between two pieces of the five-point information exceeding a preset threshold.

The process of performing cartoon conversion on the bioinformation to obtain the cartoon information may be as follows:

In this case, the bioinformation being the L face video frames is still taken as an example for description. In a case that cartoon conversion is needed, the terminal device may pull and download a cartoon conversion model from the back end (such as the back end of the settlement software). The cartoon conversion model may be a pre-trained model configured to convert the bioinformation into the cartoon information. Therefore, the terminal device may input the L face video frames into the cartoon conversion model, and extract a face local image included in each inputted face video frame through the cartoon conversion model (that is, the image including only the head of the photographed target object). A cartoon face image corresponding to the face local image included in each face video frame (which may be referred to as cartoon image for short) may be generated through the cartoon conversion model. The cartoon face image corresponding to the face local image included in each face video frame generated by the cartoon conversion model is the cartoon information corresponding to the bioinformation of the target object. In this case, cartoon conversion is performed only on the face (which may be construed as the head) of the photographed target object.

It is to be understood that, the terminal device obtains the L face video frames in turn, and the L face video frames are obtained successively at different moments. Therefore, the L face video frames may further be inputted into the cartoon conversion model successively at different moments. Each time the terminal device obtains a face video frame, the face video frame may be inputted into the cartoon conversion model, and only one face video frame may be inputted at a time. Therefore, the face video frames may be inputted into the cartoon conversion model in turn in L times to obtain the cartoon face image corresponding to each face video frame.

In a case that the L face video frames are captured, it is possible that only a part of the body of the target object (such as the neck and shoulder) is photographed. Therefore, in a case that cartoon conversion is performed on the L face video frames, the cartoon conversion may be performed not only on the face of the photographed target object (such as the face in the foregoing face local image), but also on all parts of the target object (including the head, neck and shoulder) photographed in the face video frame to obtain the corresponding cartoon image, and then the cartoon image may be used as the cartoon information corresponding to the bioinformation of the target object.

Alternatively, in a case that cartoon conversion is performed on the L face video frames, the cartoon conversion may be performed not only on the photographed target object, but also on the environment of the photographed target object (that is, the background of the target object in the face video frame) to obtain the corresponding cartoon image, and then the cartoon image may be used as the cartoon information corresponding to the bioinformation of the target object.

In addition, the foregoing cartoon conversion model may be obtained through training by the terminal device or by the back end of the settlement software. In this case, the foregoing cartoon conversion model obtained through training by the terminal device is taken as an example for description. The training process of the foregoing cartoon conversion model may be as follows:

First of all, the terminal device may obtain an initial cartoon conversion model. The initial cartoon conversion model is a generic adversary networks (GAN) model, which is an unsupervised model. The initial cartoon conversion model may include a cartoon generator (which may be called generator for short) and a cartoon discriminator (which may be called discriminator for short).

The training objective of the generator is to generate a cartoon texture image that is most similar to the inputted image by adjusting model parameters, so as to deceive the discriminator, and let the discriminator determine that the generated cartoon texture image is an actual image (that is, an image actually captured from the target object). The training objective of the discriminator is to adjust model parameters, to determine as accurately as possible that the cartoon texture image generated by the generator is not an actual image.

Specifically, the sample face image may be inputted into the cartoon generator. The sample face image may be an actual image obtained by photographing the face of a sample user. A sample cartoon face image corresponding to the sample face image may be generated in the cartoon generator, and then the sample cartoon face image generated by the cartoon generator may be inputted into the cartoon discriminator, so that the cartoon discriminator determines the probability of the sample cartoon face image being a cartoon type image. In this disclosure, this probability is called cartoon probability, which may also represent the probability of the sample cartoon face image being a cartoon texture image.

Therefore, the model parameters of the cartoon generator and the model parameters of the cartoon discriminator may be modified through the cartoon probability obtained by the cartoon discriminator, to obtain the modified model parameters of the cartoon generator and the modified model parameters of the cartoon discriminator. A plurality of sample face images may be used, and through the plurality of sample face images, the model parameters of the cartoon generator and the model parameters of the cartoon discriminator may be modified iteratively based on the same principle. In a case that the cartoon generator and cartoon discriminator obtained after model parameter modification meet the model training standard, the cartoon generator in this case may be used as the cartoon conversion model.

The model training standard may refer to the number of modifications of the model parameters (which may be construed as the number of training times) reaches a certain threshold (which may be set according to an actual application scenario), that is, when the number of modifications of the model parameters is greater than the threshold, it indicates that the model obtained after the model parameter modification meets the model training standard. Alternatively, the model training standard may refer to that the modified model parameters reach a convergence state, that is, when the modified model parameters reach the convergence state, it indicates that the model obtained after the model parameter modification meets the model training standard. The specific model training standard may further be determined according to the actual application scenario, and there is not limited herein.

The modification of the model parameters of the initial cartoon conversion model (including the model parameters of the cartoon generator and the model parameters of the cartoon discriminator) may be divided into two stages, that is, the model training process may be divided into two stages, including a first stage training process and a second stage training process. The foregoing cartoon probability includes cartoon probabilities of the two stages. The cartoon probability obtained in the first stage training process may be called a first stage cartoon probability, and the cartoon probability obtained in the second stage training process may be called a second stage cartoon probability. The sample face image used in the first stage training process may be the same as or different from the sample face image used in the second stage training process. During training of the initial cartoon conversion model, one sample face image may correspond to one cartoon probability.

Specifically, in the first stage training process for the initial cartoon conversion model, the model parameters of the cartoon discriminator may be kept unchanged, and the model parameters of the cartoon generator may be modified according to the obtained first stage cartoon probability. The objective of the modification may be to make the first stage cartoon probability reach 50%. In this case, it is considered that the cartoon discriminator cannot distinguish cartoon images from actual images, but only guess blindly. After the modification, the modified model parameters of the cartoon generator may be obtained. In this way, in the second stage training process for the initial cartoon conversion model, the modified model parameters of the cartoon generator (the modified model parameters in the first stage training process) may be kept unchanged, and the model parameters of the cartoon discriminator may be modified according to the obtained the second stage cartoon probability. The objective of the modification may be to make the first stage cartoon probability reach 100%. That is, the cartoon discriminator can distinguish cartoon images with highest accuracy. After modification, the modified model parameters of the cartoon discriminator may be obtained.

In the first stage training process, the initial cartoon conversion model may be iteratively trained through several sample face images, and in the second stage training process, the initial cartoon conversion model may further be iteratively trained through several sample face images. Each training for the initial cartoon conversion model is based on the previous training for the initial cartoon conversion model. In addition, the implementation of one first stage training process and one second stage training process may be construed as one round of training for the initial cartoon conversion model, and the initial cartoon conversion model may further be trained for several rounds. That is, the first stage training process and the second stage training process may be repeatedly and iteratively performed until the initial conversion model (including the cartoon generator and cartoon discriminator obtained after model parameter modification) obtained after model parameter modification reaches the model training standard, and then the cartoon generator in this case may be used as the cartoon conversion model.

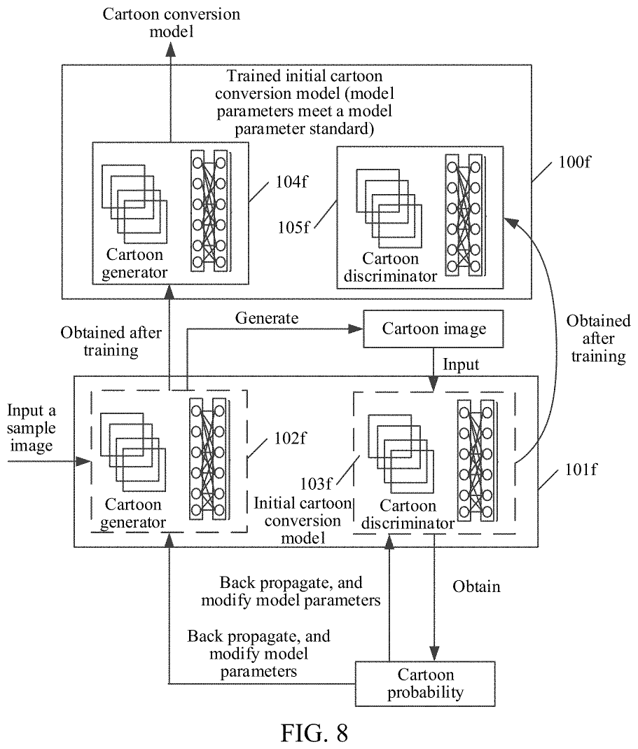

Referring to FIG. 8, FIG. 8 is a schematic diagram of a scenario of model training according to this disclosure. As shown in FIG. 8, an initial cartoon conversion model 101f includes a cartoon generator 102f and a cartoon discriminator 103f. A sample image (such as the foregoing sample face image) may be inputted into the cartoon generator 102f, and a cartoon image corresponding to the sample image may be generated through the cartoon generator 102f. Then, the cartoon image may be inputted into the cartoon discriminator 103f, and a cartoon probability for the cartoon image may be obtained through the cartoon discriminator 103f In this way, in a case that the cartoon probability is a first stage cartoon probability, the cartoon probability may be back-propagated to the cartoon generator 102f, and the model parameters of the cartoon generator 102f may be modified through the cartoon probability. In a case that the cartoon probability is a second stage cartoon probability, the cartoon probability may be back-propagated to the cartoon discriminator 103f, and the model parameters of the cartoon discriminator 103f may be modified through the cartoon probability.

The cartoon generator 102f after the model parameter modification may be used as a final cartoon generator 104f, and the cartoon discriminator 103f after the model parameter modification may be used as a final cartoon discriminator 105f In this case, the trained initial cartoon conversion model 100f may be obtained, and the cartoon generator 104f in the trained initial cartoon conversion model 100f may be used as the cartoon conversion model.

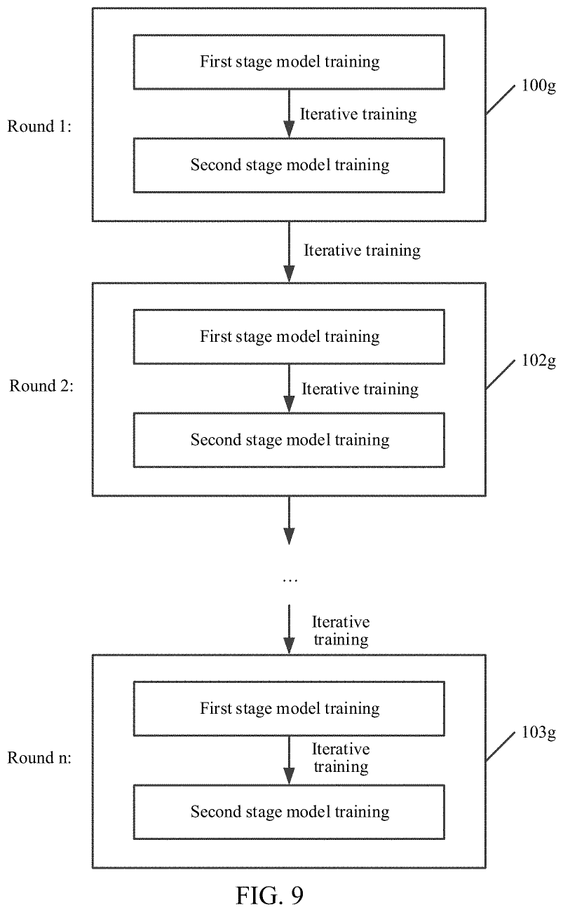

Referring to FIG. 9, FIG. 9 is a schematic diagram of a scenario of model training according to this disclosure. In fact, both the first stage training and the second stage training may be regarded as a principle or a method of model training. The first stage training is to fix the model parameters of the cartoon discriminator, and modify the model parameters of the cartoon generator through the cartoon probability. The second stage training is to fix the model parameters of the cartoon generator, and modify the model parameters of the cartoon discriminator through the cartoon probability.

As shown in FIG. 9, one round of the first stage training and the second stage training may be used as one round of training for the initial cartoon conversion model. The initial cartoon conversion model may be trained for n rounds (the first round of training to the n-th round of training). The specific value of n is determined according to the actual application scenario. After n rounds of training for the initial cartoon conversion model, it can be considered that the training for the initial cartoon conversion model is completed, and the cartoon generator in this case may be used as the cartoon conversion model.

During training for the initial cartoon conversion model (an initial GAN model), the efficiency of the algorithm involved in the initial cartoon conversion model may further be improved through a convolutional neural network, thereby improving the training efficiency, and improving the efficiency of generating the cartoon image by the cartoon conversion model in actual application of the cartoon conversion model.

In step S203, the cartoon information is displayed in the service page in a process of authenticating the target object based on the bioinformation.

In this disclosure, in the process of authenticating the target object based on the bioinformation, the terminal device may display the cartoon information corresponding to the bioinformation of the target object in the service page. The L face video frames of the target object are captured successively at different times. Therefore, the cartoon images corresponding to the face video frames are obtained by converting the L face video frames successively. After each face video frame is collected, the cartoon image corresponding to the face video frame may be displayed in the service page synchronously with a minimal delay (which may be construed as real-time). Therefore, when performing cartoon conversion on each face video frame to obtain the cartoon image corresponding to the face video frame, the terminal device may display the cartoon image corresponding to the face video frame in the service page. The cartoon images corresponding to the L face video frames may further be displayed in turn in the service page, so as to achieve the objective of synchronously displaying the cartoon images corresponding to the face video frames in the service page when the face video frames are captured.

In step S204, biological settlement information of the target order is displayed.

In this disclosure, a service page is displayed and bioinformation of the target object is collected, according to a biological settlement operation for a target order; cartoon information corresponding to the bioinformation of the target object is displayed in the service page in a process of authenticating the target object based on the bioinformation; and biological settlement information of the target order is displayed. In this way, in the method proposed in this disclosure, cartoon information corresponding to bioinformation of a target object can be displayed in a service page, which improves the security of the bioinformation of the target object. In addition, the bioinformation of the target object is not displayed directly, which can also reduce the visual impact on the target object due to direct display of the bioinformation of the target object, thereby increasing the interest of the target object in using the bioinformation to settle the target order.

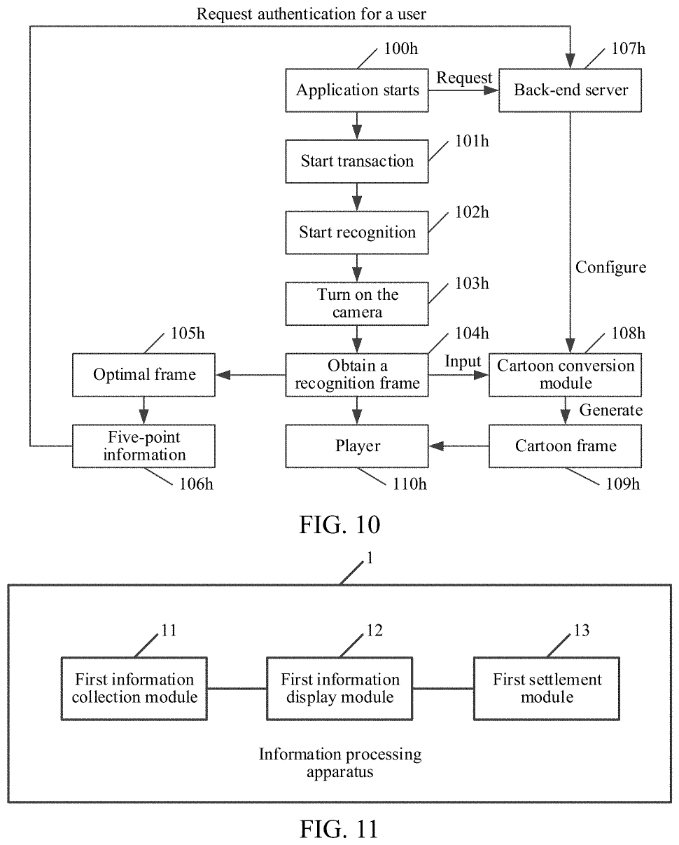

Referring to FIG. 10, FIG. 10 is a schematic flowchart of settling an order according to this disclosure. As shown in FIG. 10, first of all, as shown in a box 100h, application startup may refer to starting settlement software. After the settlement software is started, the settlement software pulls a cartoon conversion model 108h from a back-end server 107h. Then, as shown in boxes 101h to 102h, in a case that a transaction is started in the started settlement software (for example, in a case that a biological settlement operation is detected), a user in front of a camera (a camera of a terminal device where the settlement software is located) may be prepared to identify (for example, to verify the identity of the user). In this case, the camera (as shown in box 103h) is started.

Then, as shown in the box 104h, a recognition frame may be obtained through the camera. The recognition frame may be a video frame (such as the face video frame of the target object) obtained by photographing the user through the camera. The terminal device may input the recognition frame into the cartoon conversion model 108h, and a cartoon frame 109h (such as a cartoon video frame corresponding to the video frame) corresponding to the recognition frame may be generated through the cartoon conversion model 108h. In this way, the terminal device may play (display) the cartoon frame 109h in the service page through a player 110h.

After obtaining one or more recognition frames 104h, and the terminal device may select an optimal frame 105h (such as the target video frame) from the multiple recognition frames 104h, and then obtain five-point information 106h of the target object through the optimal frame (which may include the facial feature plane information and facial feature depth information of the target object). The terminal device may transmit the five-point information 106h to the back-end server 107h, and request the back-end server 107h to authenticate the target object through the five-point information 106h. After obtaining the five-point information 106h, the back-end server 107h may compare the five-point information 106h with five-point information of existing users in the settlement software in the database to determine an existing user that is the same as the target object. After determining the user identity of the target object, the determined user identity of the target object may be returned to the terminal device (for example, an avatar that may represent the user identity of the target object is returned, and the avatar is an avatar of a user account of the target object). The terminal device may display settlement confirming information including the user identity in the terminal page. After detecting a confirming operation for the settlement confirming information, the terminal device may request the back-end server 107h to use the settlement account associated with the target object to settle the target order of the target object.

Referring to FIG. 11, FIG. 11 is a schematic structural diagram of an information processing apparatus according to this disclosure. The information processing apparatus may be a computer program (including program code) run on a computer device. For example, the information processing apparatus is application software, and the information processing apparatus may be configured to perform the corresponding steps in the method provided in the embodiments of this disclosure. As shown in FIG. 11, an information processing apparatus 1 may include: a first information collection module 11, a first information display module 12, and a first settlement module 13. One or more modules, submodules, and/or units of the apparatus can be implemented by processing circuitry, software, or a combination thereof, for example.

The first information collection module 11 is configured to display a service page and collect bioinformation of a target object, in response to a biological settlement operation for a target order, the biological settlement operation being used for triggering an authentication on the target object based on the bioinformation, and settling the target order according to an authentication result.

The first information display module 12 is configured to display cartoon information corresponding to the bioinformation of the target object in the service page, in a process of authenticating the target object based on the bioinformation.

The first settlement module 13 is configured to display biological settlement information of the target order, the biological settlement information being determined at least according to the authentication result on the target object.

In an example, the bioinformation of the target object includes an i-th face video frame and a j-th face video frame obtained by photographing the target object, i is less than j, and i and j are positive integers; each of the i-th face video frame and the j-th face video frame has a face display attribute of the target object; the cartoon information corresponding to the bioinformation of the target object includes a cartoon face video frame corresponding to the i-th face video frame and a cartoon face video frame corresponding to the j-th face video frame. The first information display module 12 is specifically configured to display, in the service page, the cartoon face video frame corresponding to the i-th face video frame according to the face display attribute of the i-th face video frame, at a first moment corresponding to the i-th face video frame; and display, in the service page, the cartoon face video frame corresponding to the j-th face video frame according to the face display attribute of the j-th face video frame, in a case that time elapses from the first moment to a second moment corresponding to the j-th face video frame.

In an example, the bioinformation of the target object includes a face image of the target object; the cartoon information corresponding to the bioinformation of the target object includes a cartoon face image corresponding to the face image of the target object.

The first information display module 12 is specifically configured to display the cartoon face image in the service page according to a face display attribute of the face image of the target object; and the face display attribute includes at least one of the following: a face pose attribute, a face expression attribute, and a face accessory attribute.

In an example, the bioinformation of the target object includes a palmprint image of the target object; the cartoon information corresponding to the bioinformation of the target object includes a cartoon palmprint image corresponding to the palmprint image of the target object.

The first information display module 12 is specifically configured to display the cartoon palmprint image in the service page according to a palmprint display attribute of the palmprint image of the target object; and the palmprint display attribute includes at least one of the following: a palmprint pose attribute, and a palmprint accessory attribute.

In an example, the bioinformation of the target object includes a pupil image of the target object; the cartoon information corresponding to the bioinformation of the target object includes a cartoon pupil image corresponding to the pupil image of the target object.

The first information display module 12 is specifically configured to display the cartoon pupil image in the service page according to a pupil display attribute of the pupil image of the target object. The pupil display attribute includes at least one of the following: a pupil closure attribute, and a pupil accessory attribute.

In an example, the first information display module 12 is further configured to output a background selection list in the service page, the background selection list including M types of background information, M being a positive integer; and determine a selected background information as target background information of the cartoon information according to a selection operation for the M types of background information.

The first information display module 12 is specifically configured to display the cartoon information and the target background information in the service page synchronously.

In an example, in a case that the authentication on the target object based on the bioinformation succeeds, the biological settlement information includes settlement success information; and in a case that the authentication on the target object based on the bioinformation fails, the biological settlement information includes settlement failure information.

In an example, the biological settlement information includes settlement confirming information; and the first settlement module 13 is specifically configured to display the settlement confirming information upon detecting that the authentication on the target object based on the bioinformation succeeds, the settlement confirming information is used for supporting settlement for the target order.

The apparatus 1 further includes: a settlement determining module, configured to settle the target order according to a confirming operation for the settlement confirming information.

In an example, the settlement determining module is specifically configured to display an account selection list according to the confirming operation, the account selection list including N settlement accounts associated with the target object, N being a positive integer; determine a selected settlement account as a target settlement account according to a selection operation for the N settlement accounts in the account selection list; and use the target settlement account to settle the target order.

According to an embodiment of this disclosure, steps involved in the information processing method shown in FIG. 3 may be performed by the modules of the information processing apparatus 1 shown in FIG. 11. For example, step S101 shown in FIG. 3 may be performed by the first information collection module 11 shown in FIG. 11; step S102 shown in FIG. 3 may be performed by the first information display module 12 shown in FIG. 11; and step S103 shown in FIG. 3 may be performed by the first settlement module 13 shown in FIG. 11.

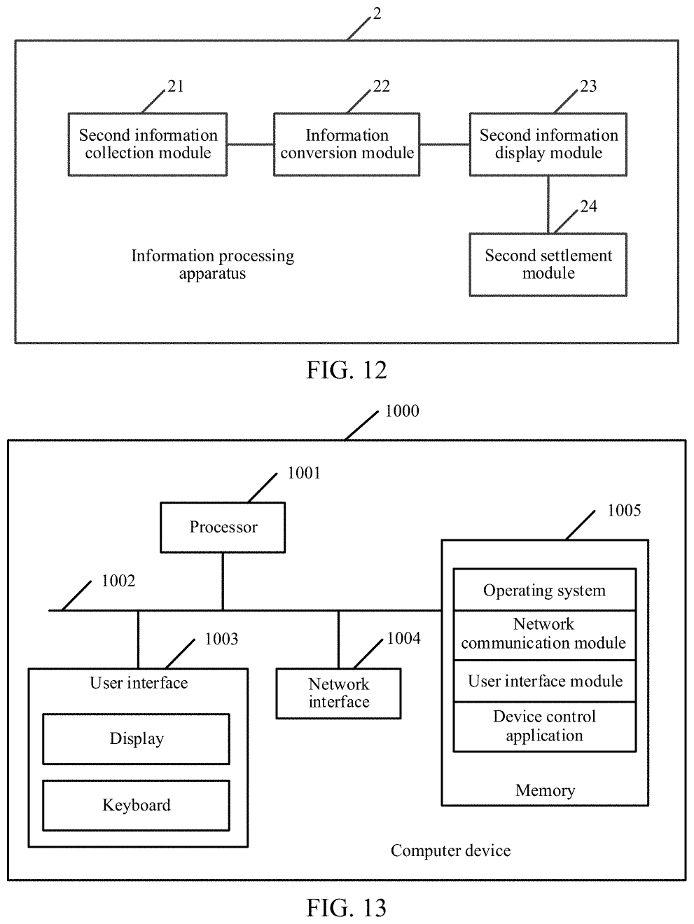

Referring to FIG. 12, FIG. 12 is a schematic structural diagram of an information processing apparatus according to this disclosure. The information processing apparatus may be a computer program (including program code) run on a computer device. For example, the information processing apparatus is application software, and the information processing apparatus may be configured to perform the corresponding steps in the method provided in the embodiments of this disclosure. As shown in FIG. 12, the information processing apparatus 2 may include: a second information collection module 21, an information conversion module 22, a second information display module 23, and a second settlement module 24. One or more modules, submodules, and/or units of the apparatus can be implemented by processing circuitry, software, or a combination thereof, for example.

The second information collection module 21 is configured to display a service page and collect bioinformation of a target object, in response to a biological settlement operation for a target order, the biological settlement operation being used for triggering an authentication on the target object based on the bioinformation, and settling the target order according to an authentication result.

The information conversion module 22 is configured to authenticate the target object based on the bioinformation and perform cartoon conversion on the bioinformation to obtain cartoon information corresponding to the bioinformation.

The second information display module 23 is configured to display the cartoon information in the service page in a process of authenticating the target object based on the bioinformation.

The second settlement module 24 is configured to display biological settlement information of the target order, the biological settlement information being determined at least according to the authentication result on the target object.

In an example, the bioinformation includes L face video frames of the target object, L being a positive integer.

The information conversion module 22 is specifically configured to select a target video frame from the L face video frames; and authenticate the target object based on the target video frame.

In an example, the information conversion module 22 is specifically configured to acquire a depth video frame corresponding to the target video frame, the depth video frame including face depth information of the target object; obtain facial feature depth information of the target object from the face depth information included in the depth video frame; obtain facial feature plane information of the target object based on the target video frame; and authenticate the target object based on the facial feature plane information and the facial feature depth information.

In an example, the information conversion module 22 is specifically configured to obtain a cartoon conversion model; extract face local images included in the L face video frames through the cartoon conversion model; generate a cartoon face image corresponding to the face local image included in each face video frame through the cartoon conversion model; and determine the cartoon face image corresponding to the face local image included in the each face video frame as the cartoon information.

In an example, the apparatus 2 further includes a model training module, configured to obtain an initial cartoon conversion model, the initial cartoon conversion model including a cartoon generator and a cartoon discriminator; generate, through the cartoon generator, a sample cartoon face image corresponding to a sample face image according to the sample face image; discriminate, through the cartoon discriminator, a cartoon probability of the sample cartoon face image being a cartoon type image according to the sample cartoon face image; modify a model parameter of the cartoon generator and a model parameter of the cartoon discriminator based on the cartoon probability; and determine the cartoon generator as the cartoon conversion model in both the cartoon generator and the cartoon discriminator meet a model training standard.

In an example, the cartoon probability includes a first stage cartoon probability and a second stage cartoon probability; and the model training module is specifically configured to keep the model parameter of the cartoon discriminator unchanged in a first stage training process for the initial cartoon conversion model, and modify the model parameter of the cartoon generator based on the first stage cartoon probability to obtain a modified model parameter of the cartoon generator; and keep the modified model parameter of the cartoon generator unchanged in a second stage training process for the initial cartoon conversion model, and modify the model parameter of the cartoon discriminator based on the second stage cartoon probability to obtain a modified model parameter of the cartoon discriminator.

According to an embodiment of this disclosure, steps in the information processing method shown in FIG. 7 may be performed by the modules of the information processing apparatus 1 shown in FIG. 12. For example, step S201 shown in FIG. 7 may be performed by the second information collection module 21 shown in FIG. 12; step S202 shown in FIG. 7 may be performed by the information conversion module 22 shown in FIG. 12; step S203 shown in FIG. 7 may be performed by the second information display module 23 shown in FIG. 12; and step S204 shown in FIG. 7 may be performed by the second settlement module 24 shown in FIG. 11.

In this disclosure, a service page is displayed and bioinformation of the target object is collected, according to a biological settlement operation for a target order; cartoon information corresponding to the bioinformation of the target object is displayed in the service page in a process of authenticating the target object based on the bioinformation; and biological settlement information of the target order is displayed. In this way, in the apparatus proposed in this disclosure, cartoon information corresponding to bioinformation of a target object can be displayed in a service page, which improves the security of the bioinformation of the target object. In addition, the bioinformation of the target object is not displayed directly, which can also reduce the visual impact on the target object due to direct display of the bioinformation of the target object, thereby increasing the interest of the target object in using the bioinformation to settle the target order.

According to an embodiment of this disclosure, the modules of the information processing apparatus 1 shown in FIG. 11 and the information processing apparatus 2 shown in FIG. 12 may be separately or wholly combined into one or several units, or one (or more) of the units thereof may further be divided into a plurality of sub-units of smaller functions. In this way, same operations may be implemented without affecting the implementation of the technical effects of the embodiments of this disclosure. The foregoing modules are divided based on logical functions. In an actual application, a function of one module may also be implemented by a plurality of units, or functions of a plurality of modules are implemented by one unit. In another embodiment of this disclosure, the information processing apparatus 1 and the information processing apparatus 2 may also include another unit. During practical application, these functions may also be cooperatively implemented by other units and may be cooperatively implemented by multiple units.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

According to an embodiment of this disclosure, a computer program (including program code) that can perform the steps in the corresponding method shown in FIG. 3 or FIG. 7 may be run on a general computing device, such as a computer, which includes processing elements and storage elements such as a central processing unit (CPU), a random access memory (RAM), and a read-only memory (ROM), to construct the information processing apparatus 1 shown in FIG. 11 or the information processing apparatus 2 shown in FIG. 12, and implement the information processing method in the embodiments of this disclosure. The computer program may be recorded in, for example, a computer-readable recording medium, and may be loaded into the foregoing computing device by using the computer-readable recording medium, and run in the computing device.

Referring to FIG. 13, FIG. 13 is a schematic structural diagram of a computer device according to this disclosure. As shown in FIG. 13, a computer device 1000 may include: processing circuitry (e.g., a processor 1001), a network interface 1004, and a memory 1005. In addition, the computer device 1000 may further include: a user interface 1003 and at least one communication bus 1002. The communication bus 1002 is configured to implement connection and communication between the components. The user interface 1003 may include a display and a keyboard. The user interface 1003 may further include a standard wired interface and a standard wireless interface. The network interface 1004 may include a standard wired interface and a standard wireless interface (such as a Wi-Fi interface). The memory 1005 may be a high-speed RAM memory, or may be a non-volatile memory, for example, at least one magnetic disk memory. The memory 1005 may be further at least one storage apparatus away from the foregoing processor 1001. As shown in FIG. 13, the memory 1005, which is used as a computer storage medium, may include an operating system, a network communication module, a user interface module, and a device control application program.

In the computer device 1000 shown in FIG. 13, the network interface 1004 may provide a network communication function; the user interface 1003 is mainly configured to provide an input interface for a user; The processor 1001 may be configured to call the device control application program stored in the memory 1005 to implement the information processing method provided in the embodiments of this disclosure.

It is to be understood that, the computer device 1000 described in this embodiment of this disclosure may implement the descriptions of the information processing method in the embodiments corresponding to FIG. 3 or FIG. 7, or the descriptions of the information processing apparatus 1 in the embodiment corresponding to FIG. 11 and the descriptions of the information processing apparatus 2 in the embodiment corresponding to FIG. 12. Details are not described herein again. In addition, the description of beneficial effects of the same method is not described herein again.

In addition, the embodiments of this disclosure further provide a computer-readable storage medium, such as a non-transitory computer-readable storage medium. The computer-readable storage medium stores a computer program executed by the information processing apparatus 1 and the information processing apparatus 2 mentioned above, and the computer program includes program instructions. When executing the program instructions, the processor can perform the descriptions of information processing method in the embodiment corresponding to FIG. 3 or FIG. 7. Therefore, details are not described herein again. In addition, beneficial effects achieved by using the same method are not described herein again. For exemplary technical details that are not disclosed in the computer storage medium embodiments of this disclosure, refer to the descriptions of the method embodiments of this disclosure.

In an example, the foregoing program instructions may be deployed to be executed on a computer device, or deployed to be executed on a plurality of computer devices at the same location, or deployed to be executed on a plurality of computer devices that are distributed in a plurality of locations and interconnected by using a communication network. The plurality of computer devices that are distributed in the plurality of locations and interconnected by using the communication network can form a blockchain network.

The computer-readable storage medium may be an information processing apparatus provided in any one of the foregoing embodiments or an internal storage unit of the computer device, for example, a hard disk or a main memory of the computer device. The computer-readable storage medium may alternatively be an external storage device of the computer device, for example, a removable hard disk, a smart memory card (SMC), a secure digital (SD) card, or a flash card equipped on the computer device. Further, the computer-readable storage medium may further comprise both an internal storage unit and an external storage device of the computer device. The computer-readable storage medium is configured to store the computer program and another program and data that are required by the computer device. The computer-readable storage medium may further be configured to temporarily store data that has been output or data to be output.

According to this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the descriptions of the information processing method in the embodiments corresponding to FIG. 3 or FIG. 7. Details are not described herein again. In addition, beneficial effects achieved by using the same method are not described herein again. For exemplary technical details that are not disclosed in the embodiments of the computer-readable storage medium of this disclosure, refer to the method embodiments of this disclosure.

What is disclosed above is merely exemplary embodiments of this disclosure, and certainly is not intended to limit the scope of this disclosure. Equivalent variations made in accordance with the claims of this disclosure shall fall within the scope of this disclosure.

What is claimed is:

1. An information processing method, comprising:
receiving a request to perform a payment operation;
displaying a service page and capturing an image of at least one part of a user, in response to the request to perform the payment operation;
performing authentication of the user based on the captured image of the at least one part of the user;
displaying, while the authentication of the user is performed, a graphical representation of the at least one part of the user that is generated based on the captured image of the at least one part of the user, the graphical representation being unique to the user; and
performing the payment operation when the user is authenticated based on the captured image of the at least one part of the user.

2. The information processing method according to claim 1, wherein the payment operation provides payment information for a target order.

3. The method according to claim 1, wherein
the capturing includes capturing a plurality of images of the at least one part of the user, the plurality of images including an i-th face video frame and a j-th face video frame, i is less than j, and i and j are positive integers, each of the i-th face video frame and the j-th face video frame being associated with face display attribute information of the user; and
the displaying the graphical representation includes displaying a plurality of graphical representations of the at least one part of the user, the plurality of graphical representations including a first cartoon face video frame corresponding to the i-th face video frame and a second cartoon face video frame corresponding to the j-th face video frame, the second cartoon face video frame being displayed in the service page after the first cartoon face video frame.

4. The method according to claim 1, wherein
the image of the at least one part of the user includes a face image of the user;
the graphical representation of the at least one part of the user includes a cartoon face image corresponding to the face image of the user; and
the displaying the graphical representation includes displaying the cartoon face image in the service page according to face display attribute information of the face image of the user, the face display attribute information indicating at least one a face pose attribute, a face expression attribute, or a face accessory attribute.

5. The method according to claim 1, wherein
the image of the at least one part of the user includes a palmprint image of the user;
the graphical representation of the at least one part of the user includes a cartoon palmprint image corresponding to the palmprint image of the user; and
the displaying the graphical representation includes displaying the cartoon palmprint image in the service page according to palmprint display attribute information of the palmprint image of the user, the palmprint display attribute information indicating at least one of a palmprint pose attribute or a palmprint accessory attribute.

6. The method according to claim 1, wherein
the image of the at least one part of the user includes a pupil image of the user;
the graphical representation of the at least one part of the user includes a cartoon pupil image corresponding to the pupil image of the user;
the displaying the graphical representation includes displaying the cartoon pupil image in the service page according to pupil display attribute information of the pupil image of the user, the pupil display attribute information indicating at least one of a pupil closure attribute or a pupil accessory attribute.

7. The method according to claim 1, further comprising:
displaying a background selection interface in the service page, the background selection interface including a plurality of backgrounds; and
determining a background of the graphical representation according to a selection of one of the plurality of backgrounds via the background selection interface,
wherein the displaying the graphical representation includes displaying the graphical representation with the background in the service page.

8. The method according to claim 1, further comprising:
displaying a payment confirmation interface when the user is authenticated based on the captured image of the at least one part of the user; and
performing the payment operation based on a confirmation operation received via the payment confirmation interface.

9. The method according to claim 8, further comprising:
displaying a payment account selection interface according to the confirmation operation; and
determining a payment account that is selected according to a selection operation via the payment account selection interface, wherein
the performing the payment operation includes performing the payment operation with the selected payment account.

10. The method according to claim 1, further comprising:
performing graphical representation conversion on the image of the at least one part of the user to obtain the graphical representation.

11. The method according to claim 10, further comprising:
selecting the image of the at least one part of the user from a plurality of face video frames.

12. The method according to claim 11, wherein the performing the authentication comprises:
obtaining a depth video frame corresponding to the image of the at least one part of the user;
obtaining facial feature depth information of the user from the depth video frame;
obtaining facial feature plane information of the user based on the image of the at least one part of the user; and
performing the authentication on the user based on the facial feature plane information and the facial feature depth information.

13. The method according to claim 11, wherein
the image of the at least one part of the user includes a cartoon face image, and
the performing the graphical representation conversion comprises:
obtaining a cartoon conversion model;
extracting face local images included in the plurality of face video frames using the cartoon conversion model; and
generating the cartoon face image based on the extracted face local images.

14. The method according to claim 13, further comprising:
obtaining an initial cartoon conversion model, the initial cartoon conversion model including a cartoon generator and a cartoon discriminator;
generating, through the cartoon generator, a sample cartoon face image according to a sample face image;
discriminating, through the cartoon discriminator, at least one cartoon probability of the sample cartoon face image being a cartoon type image according to the sample cartoon face image;
modifying a model parameter of the cartoon generator and a model parameter of the cartoon discriminator based on the at least one cartoon probability; and
determining the cartoon generator as the cartoon conversion model when both the cartoon generator and the cartoon discriminator meet a model training standard.

15. The method according to claim 14, wherein
the discriminating the at least one cartoon probability includes discriminating a first stage cartoon probability and a second stage cartoon probability; and
the modifying the model parameter of the cartoon generator and the model parameter of the cartoon discriminator comprises:
modifying the model parameter of the cartoon generator based on the first stage cartoon probability; and
modifying the model parameter of the cartoon discriminator based on the second stage cartoon probability.

16. An information processing apparatus, comprising:
processing circuitry configured to:
receive a request to perform a payment operation;
display a service page and capture an image of at least one part of a user, in response to the request to perform the payment operation;
perform authentication of the user based on the captured image of the at least one part of the user;
display, while the authentication of the user is performed, a graphical representation of the at least one part of the user that is generated based on the captured image of the at least one part of the user, the graphical representation being unique to the user; and
perform the payment operation when the user is authenticated based on the captured image of the at least one part of the user.

17. The information processing apparatus according to claim 16, wherein
the image of the at least one part of the user includes a face image of the user;
the graphical representation of the at least one part of the user includes a cartoon face image corresponding to the face image of the user; and
the processing circuitry is configured to display the cartoon face image in the service page according to face display attribute information of the face image of the user, the face display attribute information indicating at least one a face pose attribute, a face expression attribute, or a face accessory attribute.

18. The information processing apparatus according to claim 16, wherein
the image of the at least one part of the user includes a palmprint image of the user;
the graphical representation of the at least one part of the user includes a cartoon palmprint image corresponding to the palmprint image of the user; and
the processing circuitry is configured to display the cartoon palmprint image in the service page according to palmprint display attribute information of the palmprint image of the user, the palmprint display attribute information indicating at least one of a palmprint pose attribute or a palmprint accessory attribute.

19. The information processing apparatus according to claim 16, wherein
the image of the at least one part of the user includes a pupil image of the user;
the graphical representation of the at least one part of the user includes a cartoon pupil image corresponding to the pupil image of the user;
the processing circuitry is configured to display the cartoon pupil image in the service page according to pupil display attribute information of the pupil image of the user, the pupil display attribute information indicating at least one of a pupil closure attribute or a pupil accessory attribute.

20. A non-transitory computer-readable storage medium, storing instructions which when executed by a processor cause the processor to perform:
receiving a request to perform a payment operation;
displaying a service page and capturing an image of at least one part of a user, in response to the request to perform the payment operation;
performing authentication of the user based on the captured image of the at least one part of the user;
displaying, while the authentication of the user is performed, a graphical representation of the at least one part of the user that is generated based on the captured image of the at least one part of the user, the graphical representation being unique to the user; and
performing the payment operation when the user is authenticated based on the captured image of the at least one part of the user.
